(19) United States
(12) Patent Application Publication
(10) Pub. No.: US 2016/0150096 A1
(43) Pub. Date: May 26, 2016

(54) METHOD AND MOBILE COMMUNICATION DEVICE FOR CHANGING SETTING OF MOBILE COMMUNICATION DEVICE

(71) Applicant: MEDIATEK INC., Hsin-Chu, Taiwan (CN)

(72) Inventors: Chia-Ping Chen, Nantou County (TW); Yu-Wen Huang, Taipei City (TW); Shaw-Min Lei, Hsinchu County (TW)

(21) Appl. No.: 14/899,126

(22) PCT Filed: May 19, 2015
(86) PCT No.: PCT/CN2015/079285

§ 371 Date: Dec. 17, 2015

Related U.S. Application Data
(60) Provisional application No. 62/000,169, filed on May 19, 2014.

(51) Int. Cl. H04M 19/04

(52) U.S. Cl. CPC H04M 19/042; H04M 19/045

(57) ABSTRACT

A method for changing a setting of a mobile communication device is disclosed. The method includes receiving context information of the mobile communication device, changing the setting of the mobile communication device according to the context information and a user preference rule, and updating the user preference rule according to the context information and the changed setting.

### CROSS REFERENCE TO RELATED APPLICATIONS

This application claims the benefit of U.S. Provisional Application No. 62/000,169 filed on May 19, 2014, the contents of which are incorporated herein.

### TECHNICAL FIELD

The present invention relates to a method for changing a setting of a mobile communication device, and more particularly to a method for intelligently learning user habits of a mobile communication device.

### BACKGROUND

With the popularity of mobile phones, people frequently get annoyed by phone rings due to improper volume settings. For example, people might get embarrassed if the volume is too loud in an important and serious business meeting. On the other hand, people might miss important calls or notifications if the volume is mute or too low.

Even if a mobile phone user always remembers to timely change the volume setting in accordance with the occasion, the user might feel cumbersome to adjust the phone setting whenever the occasion changes.

Thus, the industry is urged to develop an automatic phone setting mechanism.

### SUMMARY

Therefore, one of the objectives of the present invention is to provide a method and a mobile communication device for changing a setting of a mobile communication device in accordance with context information and a user preference rule of the mobile communication device.

According to an embodiment of the present invention, a method for changing a setting of a mobile communication device is disclosed. The method includes receiving context information of the mobile communication device, changing the setting of the mobile communication device according to the context information and a user preference rule, and updating the user preference rule according to the context information and the changed setting.

According to an embodiment of the present invention, a mobile communication device is disclosed. The mobile communication device includes a processing unit, a storage unit for storing a user preference rule, and a program code stored in the storage unit. The program code instructs the processing unit to execute the following steps: receiving context information of the mobile communication device, changing setting of the mobile communication device according to the context information and the user preference rule, and updating the user preference rule in the storage unit according to the context information and the changed setting.

According to the above-mentioned embodiments, by updating the user preference rule, the method and corresponding mobile communication device may achieve the advantage that the mobile communication learns habits of the user for automatic setting change or setting suggestion providing, so as to replace cumbersome manual setting change.

### BRIEF DESCRIPTION OF DRAWINGS

These and other objectives of the present invention will no doubt become obvious to those of ordinary skill in the art after reading the following detailed description of the preferred embodiment that is illustrated in the various figures and drawings.

FIG. 1 is a flowchart of a method according to an embodiment of the present invention.

FIG. 2 is a flowchart of a method according to an embodiment of the present invention.

FIG. 3 is a flowchart of a method according to an embodiment of the present invention.

### DETAILED DESCRIPTION

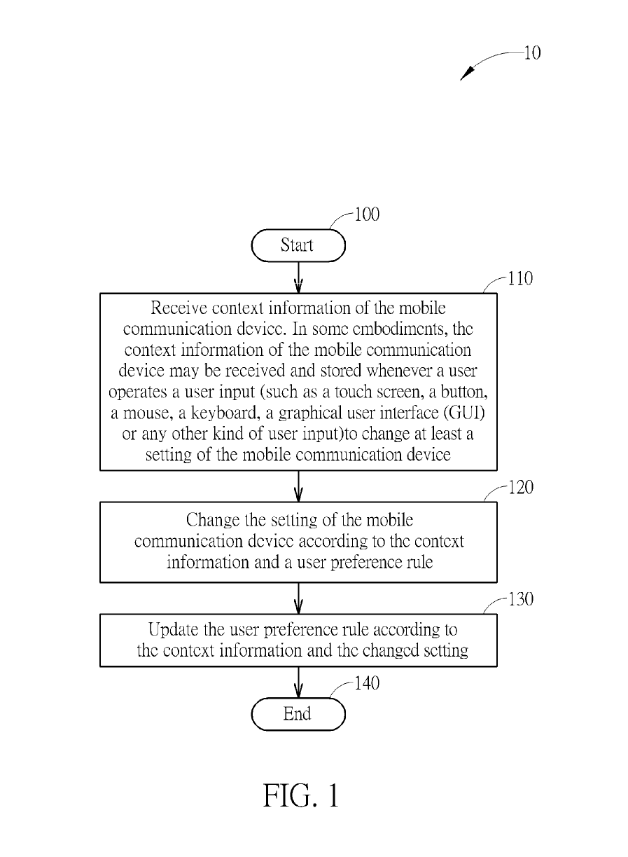

Please refer to FIG. 1, which is a flowchart of a method 10 according to an embodiment of the present invention. Steps of the flowchart shown in FIG. 1 need not be in the exact order shown and need not be contiguous, that is, other steps may be intermediate. The steps are detailed in the following:

Step 100: Start.

Step 110: Receive context information of the mobile communication device. In some embodiments, the context information of the mobile communication device may be received and stored whenever a user operates a user input (such as a touch screen, a button, a mouse, a keyboard, a graphical user interface (GUI) or any other kind of user input)to change at least a setting of the mobile communication device.

Step 120: Change the setting of the mobile communication device according to the context information and a user preference rule.

Step 130: Update the user preference rule according to the context information and the changed setting.

Step 140: End.

Specifically, the context information may be at least one of current time, a current location of the mobile communication device, a current activity of a user of the mobile communication device, a current environment parameter of the mobile communication device, a user schedule, at least one previous phone event of the mobile communication device, any other type of information or their combinations. The context information may be downloaded or received from the network, determined based on data stored in the mobile communication device, received from a sensor by the mobile communication device, received through a user input (such as a touch screen, a button, a mouse, a keyboard, a graphical user interface (GUI) or any other kind of user input), or received utilizing the combination thereof.

The user preference rule may include settings corresponding to different context information, such as a setting of the mobile communication device, an event record of the mobile communication device, a reservation time of setting change, an end time of setting change, any other setting of the mobile communication device or their combinations.

With the context information, the mobile communication device may automatically change the setting of the mobile communication device based on the updated user preference rule. For example, when the context information indicates that the mobile communication device is located in a library or a museum, the mobile communication device automatically changes volume to mute based on the updated user preference rule. On the contrary, when the context information indicates that the mobile communication device is located in a noisy street, the mobile communication device automatically changes the volume to a maximum volume value based on the updated user preference rule. As a result, if the user changes the volume setting on such location or occasion once, the user may avoid embarrassing situations even if the user forgets to modify the volume setting.

Since users may have different response to an identical occasion change, the mobile communication device is personalized by updating the user preference rule. For example, when the volume of the mobile communication device is changed to mute in a library, the mobile communication device updates the user preference rule to record the event. As more and more events are recorded, the mobile communication device may automatically change the setting more precisely, so as to approach a user's actual response to the occasion change.

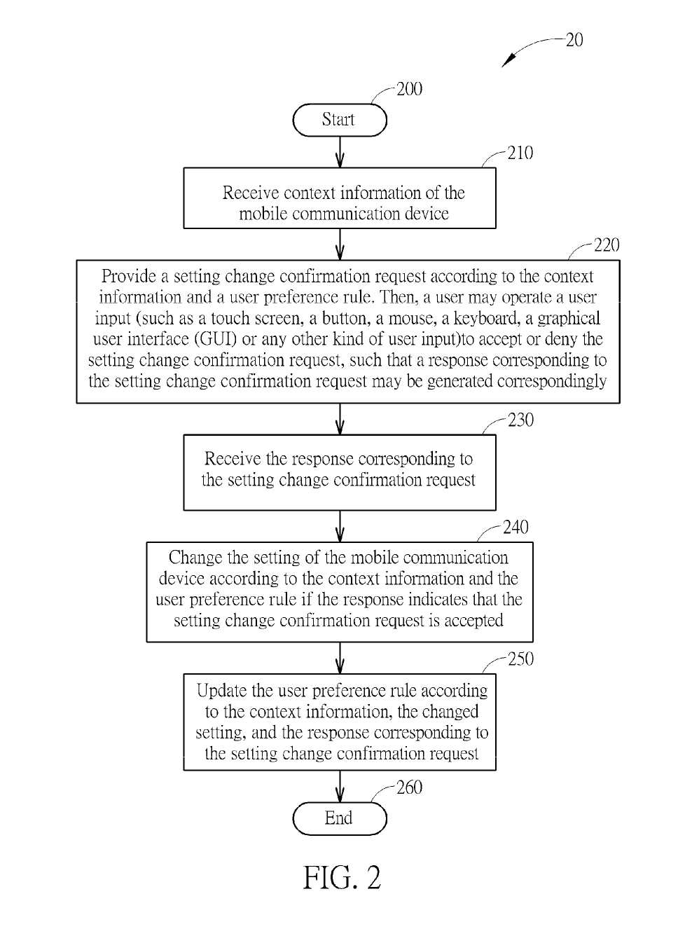

Since the context information may be not enough to estimate the user's actual response, the method 10 may be modified to take the user's actual response into consideration. Please refer to FIG. 2, which is a flowchart of a method 20 according to an embodiment of the present invention. Steps of the method 20 are detailed in the following:

Step 200: Start.

Step 210: Receive context information of the mobile communication device.

Step 220: Provide a setting change confirmation request according to the context information and a user preference rule. Then, a user may operate a user input (such as a touch screen, a button, a mouse, a keyboard, a graphical user interface (GUI) or any other kind of user input)to accept or deny the setting change confirmation request, such that a response corresponding to the setting change confirmation request may be generated correspondingly.

Step 230: Receive the response corresponding to the setting change confirmation request.

Step 240: Change the setting of the mobile communication device according to the context information and the user preference rule if the response indicates that the setting change confirmation request is accepted.

Step 250: Update the user preference rule according to the context information, the changed setting, and the response corresponding to the setting change confirmation request.

Step 260: End.

In consequence, the setting of the mobile communication device is changed only if the user agrees with the setting change confirmation request. For example, when the context information indicates that the current time is 10:00 PM and the current location is at the user's house, the mobile communication device sends the setting change confirmation request to the user to query whether to decrease the volume value. If the user denies the setting change confirmation request, the user preference rule is updated correspondingly. As a result, the mobile communication device may not send the setting change confirmation request again if the same or similar context information is received.

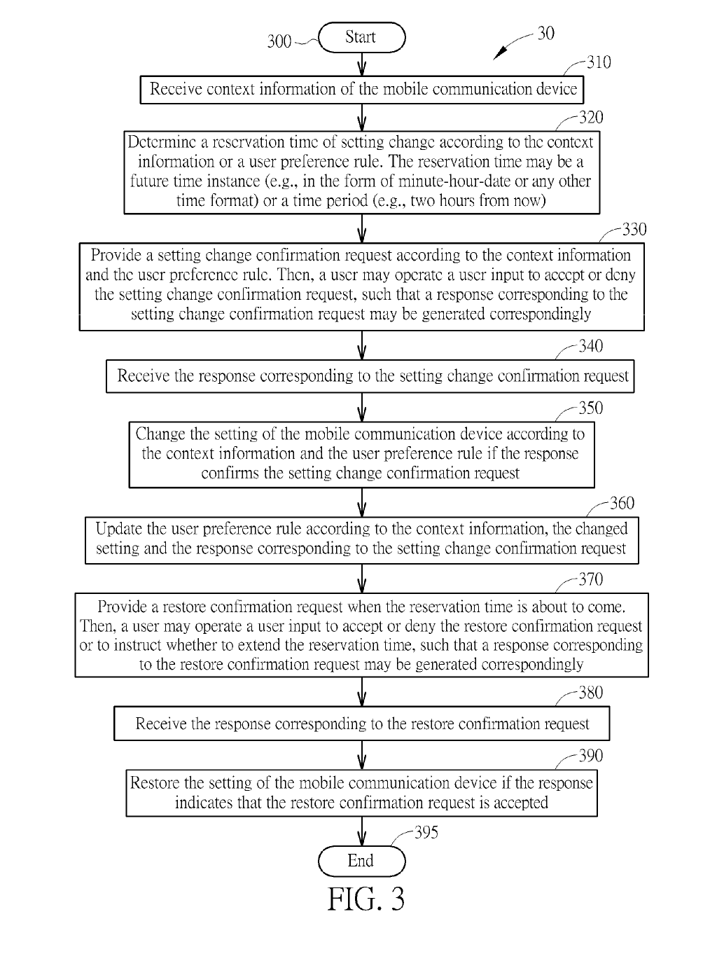

Please refer to FIG. 3, which is a flowchart of a method 30 according to an embodiment of the present invention. Steps of the method 30 are detailed in the following:

Step 300: Start.

Step 310: Receive context information of the mobile communication device.

Step 320: Determine a reservation time of setting change according to the context information or a user preference rule. The reservation time may be a future time instance (e.g., in the form of minute-hour-date or any other time format) or a time period (e.g., two hours from now).

Step 330: Provide a setting change confirmation request according to the context information and the user preference rule. Then, a user may operate a user input to accept or deny the setting change confirmation request, such that a response corresponding to the setting change confirmation request may be generated correspondingly.

Step 340: Receive the response corresponding to the setting change confirmation request.

Step 350: Change the setting of the mobile communication device according to the context information and the user preference rule if the response confirms the setting change confirmation request.

Step 360: Update the user preference rule according to the context information, the changed setting and the response corresponding to the setting change confirmation request.

Step 370: Provide a restore confirmation request when the reservation time is about to come. Then, a user may operate a user input to accept or deny the restore confirmation request or to instruct whether to extend the reservation time, such that a response corresponding to the restore confirmation request may be generated correspondingly.

Step 380: Receive the response corresponding to the restore confirmation request.

Step 390: Restore the setting of the mobile communication device if the response indicates that the restore confirmation request is accepted.

Step 395: End.

For example, when the user enters a conference room, the mobile communication device provides the setting change confirmation request to query the user whether to change the volume to mute within a reservation time (such as for two hours or end at 19:00). In one embodiment, if the user agrees with the setting change confirmation request, the mobile communication device may change the volume to mute within the reservation time, and restore or query for restoring the volume back to an original value in two hours later. In some other embodiments, if the user agrees with the setting change confirmation request, the mobile communication device may change the volume to mute within the reservation time, and query for adjusting the volume setting when the reservation time is about to come.

Note that, the received context information may be utilized for determining another type of context information, such as the current activity of the user. For example, the received context information shows that the current time is 07:30 PM, the current location is at a stadium and moves at a speed of nine kilometer per hour, and the temperature is 20° C., the mobile communication device determines that the user's current activity is a jogging exercise. In this embodiment, the mobile communication device may be set to no-vibration when it is determined that the user is jogging.

The received context information may be related to the current location. In some embodiments, such context information may be directly related to the current location, such as a global positioning system (GPS) coordinate, an indoor positioning information or any other information for positioning. Then, the current location may be further determined according to mapping related information, such as a look-up table, geographic information system (GIS) information or any other mapping related information. In some other embodiments, another type of context information may be utilized for determining the current location. For example, if a movie ticket for tonight is booked, the location for tonight may be a movie theater, and the mobile communication device may be automatically change to the setting corresponding to the movie theater or provide a corresponding suggestion. In some embodiments, the ticket booking may be detected if the ticket is booked through the mobile communication. In some other embodiments, the mobile communication device may detect the ticket booking by checking information about a movie or a ticket, such as an email about ticket booking, the user's schedule, an e ticket or any other related information. For another example, if the mobile communication device detects that it is at a dark and noisy place, the current location may be a theater, the mobile communication device may automatically perform adjustment or provide suggestion correspondingly.

According to another embodiment of the present invention, the current activity is determined according to types of other devices communicated with or detected by the mobile communication device. For example, when the mobile communication device detects a projector via Wi-Fi, the mobile communication device determines that the current activity is a conference. Then, the mobile communication device may automatically change to the setting corresponding to the conference status or provide a suggestion about the conference status. In some other embodiments, other devices may be detected or communicated through any other wireless communication protocol (such as, Bluetooth, NFC, Zigbee, peer to peer networking, or other wireless communication protocol), which should not be limited in this disclosure.

According to an embodiment of the present invention, the user preference rule can be updated or initiated according to public context information, such as a public experience rule, a society behavior rule, any other type of public context information, or their combinations. The public experience rule may be determined based on big data which records behaviors of massive people having similar or same context information. For example, most people mute their cell phones when entering a specific facility (e.g. a library) and switch volume on when exiting. In some embodiments, these people's devices may broadcast or share their data to the mobile communication device or a specific server through a wireless communication protocol (such as, Bluetooth, NFC, Zigbee, peer to peer networking, or other wireless communication protocol). Then, the mobile communication device or the specific server may determine the public experience rule accordingly. It is possible to update the user preference rule according to the public experience rule, especially for a user who enters this facility for the first time.

The society behavior rule may include local laws, school regulations, etc. For example, the mobile communication device may change the volume to mute in a classroom based on the school regulations.

In some embodiments, a minimum and/or a maximum volume of the mobile communication device may be set, and the mobile communication device may change to a volume or provide a suggested volume between the minimum and the maximum. The mobile communication device may also automatically change the maximum volume value and the minimum volume value or provide a suggestion about such setting adjustment according to the context information and the user preference rule. For example, if the user preference rule indicates that the user frequently misses several phone calls in a specific context, the mobile communication device may automatically increase the minimum volume value. For another example, if the user or other people can always answer their phone in a specific volume level, the maximum volume value may be decreased directly or decreased based on such specific volume level.

Other than the volume setting, the mobile communication device may automatically change an operation mode, such as a power management mode, a wireless communication mode and a program pre-loading mode or provide related suggestions according to the context information and the user preference rule. For example, according to personal habits summarized in the user preference rule, the received context information may trigger the mobile communication device to switch into a power saving mode (for example, at a sleep time of the user or corresponding to other specific context information), switch the wireless communication mode from 4G/LTE to Wi-Fi (for example, when the user is at home or corresponding to other specific context information), or pre-load an APP program (for example, at 00:05 PM because the APP program is frequently activated by the user at lunch time or corresponding to other specific context information).

The method 10, 20, or 30 may be programed as a program code stored in a mobile communication device. For example, the mobile communication device may include a processing unit, a storage unit. The storage unit is utilized for storing the program code. As such, the program code instructs the processing unit to execute the method 10, 20, or 30. Operations of the methods 10, 20, and 30 are explained above, and are not further narrated herein.

To sum up, the mobile communication device learns the user's habits, and updates the user preference rule accordingly. As a result, by updating the user preference rule, the longer the mobile communication device is used, the more precise the automatic setting change or setting suggestion is. The user no longer needs to manually set the mobile communication device whenever the occasion changes.

Those skilled in the art will readily observe that numerous modifications and alterations of the device and method may be made while retaining the teachings of the invention. Accordingly, the above disclosure should be construed as limited only by the metes and bounds of the appended claims.

1. A method for changing a setting of a mobile communication device, comprising:
receiving context information of the mobile communication device;
changing the setting of the mobile communication device according to the context information and a user preference rule; and
updating the user preference rule according to the context information and the changed setting.

2. The method of claim 1, further comprising:
providing a setting change confirmation request according to the context information and the user preference rule; and
receiving a response corresponding to the setting change confirmation request.

3. The method of claim 2, wherein the step of changing the setting of the mobile communication device according to the context information and the user preference rule comprises changing the setting of the mobile communication device according to the context information and the user preference rule if the response indicates that the setting change confirmation request is accepted.

4. The method of claim 2, wherein the user preference rule is updated further according to the response corresponding to the setting change confirmation request.

5. The method of claim 2, further comprising determining a reservation time of setting change according to the context information or the user preference rule.

6. The method of claim 5, further comprising:
providing a restore confirmation request when the reservation time is about to come; and
receiving a response corresponding to the restore confirmation request.

7. The method of claim 6, further comprising restoring the setting of the mobile communication device if the response corresponding to the restore confirmation request indicates that the restore confirmation request is accepted.

8. The method of claim 1, wherein the context information of the mobile communication device is received whenever at least a setting of the mobile communication device is changed through a user input of the mobile communication device.

9. The method of claim 1, wherein the context information comprises at least one of current time, a current location of the mobile communication device, a current activity of a user of the mobile communication device, a current environment parameter of the mobile communication device, a user schedule of the mobile communication device, and at least one previous event of the mobile communication device.

10. The method of claim 9, wherein the current activity is determined according to a type of a device communicated with or detected by the mobile communication device.

11. The method of claim 1, wherein the user preference rule comprises at least one of a setting of the mobile communication device, a event record of the mobile communication device, a reservation time of setting change, and a end time of setting change.

12. The method of claim 1, further comprising updating or initiating the user preference rule according to at least one of a public experience rule and a society behavior rule.

13. The method of claim 1, wherein the step of changing the setting of the mobile communication device according to the context information and the user preference rule comprises changing at least one of a volume setting and an operating mode of the mobile communication device according to the context information and the user preference rule.

14. The method of claim 13, wherein the volume setting corresponds to at least one of a current volume value, a maximum volume value and a minimum volume value of the mobile communication device, and the operating mode comprises at least one of a power management mode, a wireless communication mode and a program pre-loading mode.

15. A mobile communication device, comprising:
a processing unit; and
a storage unit, for storing a user preference rule and a program code,
wherein the program code instructs the processing unit to execute the following steps:
receiving context information of the mobile communication device;
changing setting of the mobile communication device according to the context information and the user preference rule; and
updating the user preference rule in the storage unit according to the context information and the changed setting.

16. The mobile communication device of claim 15, wherein the program code further instructs the processing unit to execute the following steps:
providing a setting change confirmation request according to the context information and the user preference rule; and
receiving a response corresponding to the setting change confirmation request.

17. The mobile communication device of claim 16, wherein the step of changing the setting of the mobile communication device according to the context information and the user preference rule comprises changing the setting of the mobile communication device according to the context information and the user preference rule if the response indicates that the setting change confirmation request is accepted.

18. The mobile communication device of claim 16, wherein the user preference rule is updated further according to the response corresponding to the setting change confirmation request.

19. The mobile communication device of claim 16, wherein the program code further instructs the processing unit to execute the following step:
determining a reservation time of setting change according to the context information or the user preference rule.

20. The mobile communication device of claim 19, wherein the program code further instructs the processing unit to execute the following steps:
providing a restore confirmation request when the reservation time is about to come; and
receiving a response corresponding to the restore confirmation request.

21. The mobile communication device of claim 20, wherein the program code further instructs the processing unit to execute the following step:
restoring the setting of the mobile communication device if the response corresponding to the restore confirmation request indicates that the restore confirmation request is accepted.

22. The mobile communication device of claim 15, wherein the context information of the mobile communication device is received whenever at least a setting of the mobile communication device is changed through a user input of the mobile communication device.

23. The mobile communication device of claim 15, wherein the context information comprises at least one of current time, a current location of the mobile communication device, a current activity of a user of the mobile communication device, a current environment parameter of the mobile communication device, a user schedule of the mobile communication device, and at least one previous event of the mobile communication device.

24. The mobile communication device of claim 23, wherein the current activity is determined according to a type of a device communicated with or detected by the mobile communication device.

25. The mobile communication device of claim 15, wherein the user preference rule comprises at least one of a setting of the mobile communication device, a event record of the mobile communication device, a reservation time of setting change, and a end time of setting change.

26. The mobile communication device of claim 15, wherein the program code further instructs the processing unit to execute the following step:
updating or initiating the user preference rule according to at least one of a public experience rule and a society behavior rule.

27. The mobile communication device of claim 15, wherein the step of changing the setting of the mobile communication device according to the context information and the user preference rule comprises changing at least one of a volume setting and an operation mode of the mobile communication device according to the context information and the user preference rule.

28. The mobile communication device of claim 27, wherein the volume setting corresponds to at least one of a current volume value, a maximum volume value and a minimum volume value of the mobile communication device, and the operating mode comprises at least one of a power management mode, a wireless communication mode and a program pre-loading mode.
